(19) United States
(12) Patent Application Publication
(10) Pub. No.: US 2012/0043490 A1
(43) Pub. Date: Feb. 23, 2012

(54) PRE-OXIDATION OF ENGINE VALVES AND SEAT INSERTS FOR IMPROVED LIFE

(75) Inventors: Eric Kelsey, Hennepin, IL (US); Nathaniel S. L. Phillips, Morton, IL (US); Jeff A. Jensen, Dunlap, IL (US)

(73) Assignee: Caterpillar Inc., Peoria, IL (US)

(21) Appl. No.: 12/859,563

(22) Filed: Aug. 19, 2010

(51) Int. Cl. F16K 1/42

(52) U.S. Cl. 251/359

(57) ABSTRACT

A valve seat insert operable with a valve to selectively open and close a passage to a cylinder in an internal combustion engine. The valve seat insert includes a cobalt alloy base including at least about 40 wt % Co and at least about 5 wt % Cr. An oxide scale coating is disposed on at least a wear face of the valve seat insert adapted to engage the valve and optionally on a portion of the valve.

### STATEMENT REGARDING FEDERALLY SPONSORED RESEARCH AND DEVELOPMENT

This disclosure was made in part with Government support under CRADA NFE-07-00995 between Caterpillar Inc. and UT-Battelle, LLC under its Prime Contract with the U.S. Department of Energy for the operation of the Oak Ridge National Laboratory. The Government may have certain rights in this disclosure.

### TECHNICAL FIELD

This patent disclosure relates generally to internal combustion engine valve assemblies. More particularly this disclosure relates to wear resistant valve seat inserts, including a pre-applied oxide coating for use in combination with valves for selectively opening and closing ports to cylinder combustion chambers in an internal combustion engine.

### BACKGROUND

Internal combustion engines are high-temperature environments that may incorporate valve assemblies to control the flow of fuel mixtures and exhaust products into and out of cylinder combustion chambers during combustion cycles. Such valve assemblies may incorporate an angled valve seat insert that engages a corresponding valve head to form a desired sealing relationship. During multiple engagement cycles between the valve and the valve seat insert, the contacting surfaces may experience wear, eventually resulting in the need to replace the valve seat insert and/or the valve. The valve seat inserts may require replacement sooner than the corresponding valves. Moreover, the rate of wear of the valve seat inserts tends to be greatest during an initial start-up period following installation

In the past, use of oxidation treatments to protect titanium-based valve components in internal combustion engines was advocated. For example, a surface treatment method of a titanium alloy valve is taught by Japanese Laid-open Patent Publication Number 11-117056 ('7056), in which the titanium alloy valve is oxidized in order to produce a wear resistant hard oxide film on its surface and to eliminate the need for use of a copper series valve seat. In '7056, an engine valve made from a metastable β titanium alloy is exemplified as the titanium part, because it has been generally known that when an α-β titanium alloy is oxidized, its fatigue strength is reduced. However, as best understood the teachings in this reference are limited to valves formed from a titanium which readily forms a stable passive oxide coating. There is no recognition of using oxidation treatments to protect valve seats formed from cobalt alloys or valves formed from nickel alloys (i.e. Group VIII elements), which have a more positive free energy of formation than oxides of titanium.

### SUMMARY

The present disclosure describes, in one aspect, a valve seat insert. The valve seat insert comprises a cobalt alloy base including at least about 40 wt % Co in combination with at least about 5 wt % Cr. Further, the valve seat insert includes a wear face having an oxide scale coating disposed thereon, the oxide scale coating having a thickness of less than about 1000 nm and a surface composition including chromium, oxygen and cobalt.

The present disclosure describes, in another aspect, a valve assembly adapted to selectively open and close a passage to a cylinder in an internal combustion engine during a plurality of combustion cycles. The valve assembly comprises a valve seat insert having a cobalt alloy base including at least about 40 wt % Co and at least about 5 wt % Cr. The valve assembly also comprises a moveable valve including a valve head, the valve head being at least partially covered with a cobalt alloy overlay. The valve seat insert further includes a wear face having a first oxide scale coating disposed thereon, the first oxide scale coating having a thickness of less than about 1000 nm and a surface composition including less than about 10 wt % Co.

The present disclosure describes, in yet another aspect, a method for extending the useful life of a valve seat insert for use in conjunction with a valve adapted to selectively open and close a passage to a cylinder in an internal combustion engine during a plurality of combustion cycles. The method comprises forming the valve seat insert from a cobalt alloy including at least about 40% Co and least about 5% Cr. The method also comprises subjecting the valve seat insert to an oxidizing heat treatment to form an oxide scale coating disposed on a valve seat insert wear face that is adapted to engage the valve, wherein the oxide scale coating has a thickness up to about 1000 nm.

### BRIEF DESCRIPTION OF THE DRAWING(S)

FIG. 1 is a diagrammatic illustration of a machine according to an exemplary and disclosed embodiment.

FIG. 2 is a diagrammatic illustration of an exemplary internal combustion engine.

FIG. 3 is a diagrammatic illustration of an exemplary valve assembly for use in an internal combustion engine.

FIG. 4 is a perspective sectional view of an exemplary valve seat insert for use in a valve assembly in an internal combustion engine.

FIG. 5 is a diagrammatic illustration showing an oxide scale coating on a wear face of an exemplary valve seat insert.

### DETAILED DESCRIPTION

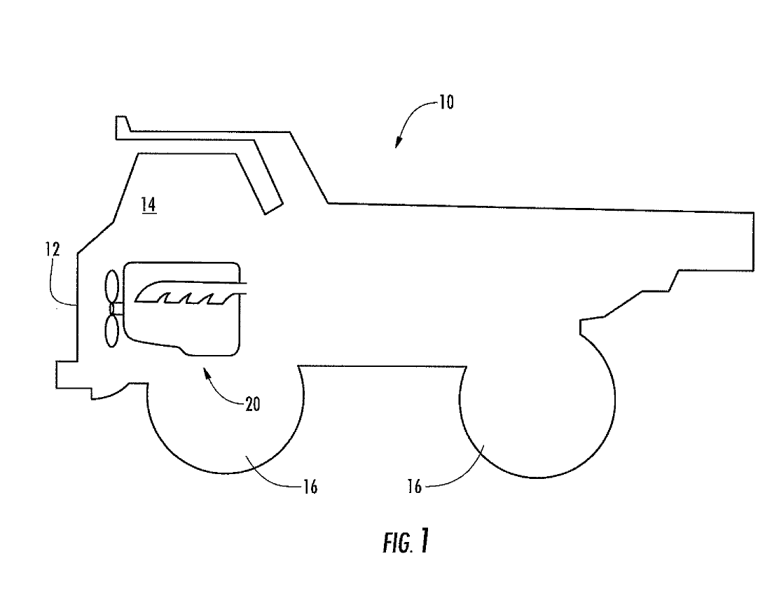

FIG. 1 illustrates an exemplary machine 10 that includes a frame 12, an operator station 14, one or more traction devices 16, and an internal combustion engine 20 that combusts fuel and generates an exhaust stream. Although FIG. 1 shows machine 10 as a truck, machine 10 could be any type of machine having an internal combustion engine 20. Accordingly, the traction devices 16 may be any suitable type of traction device such as, for example, wheels (as shown in FIG. 1), tracks, belts, or combinations thereof. The machine 10 may also be substantially non-mobile, such as an electric generator or a well-service rig, which incorporates an internal combustion engine as a power source.

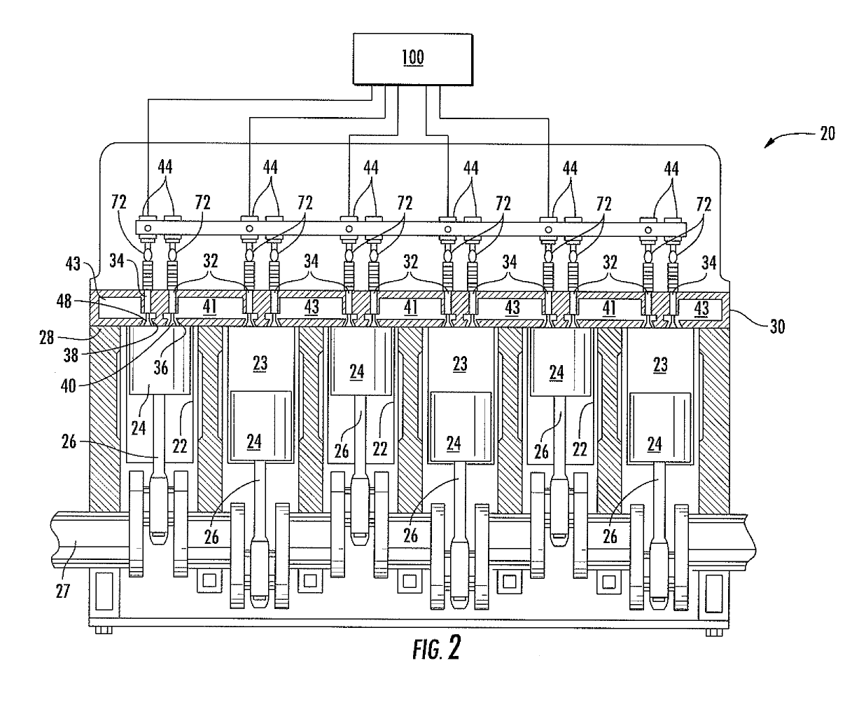

An exemplary embodiment of internal combustion engine 20 is illustrated in FIG. 2. For the purposes of the present disclosure, internal combustion engine 20 is depicted and described as a four stroke diesel engine. One skilled in the art will recognize, however, that internal combustion engine 20 may be any other type of internal combustion engine, such as, for example, a gasoline or natural gas internal combustion engine.

As illustrated in FIG. 2, internal combustion engine 20 includes an engine block 28 that defines a plurality of cylinders 22. A piston 24 is slidably disposed within each cylinder 22 to define a combustion chamber 23. In the illustrated embodiment, internal combustion engine 20 includes six cylinders 22 and six associated pistons 24. One skilled in the art will readily recognize that the internal combustion engine 20 may include a greater or lesser number of pistons 24 and that pistons 24 may be disposed in an “in-line” configuration, a “V” configuration, or any other conventional configuration. As also shown in FIG. 2, internal combustion engine 20 includes a crankshaft 27 that is rotatably disposed within engine block 28. Connecting rod 26 connects each piston 24 to crankshaft 27. Each piston 24 is coupled to the crankshaft 27 so that a sliding motion of piston 24 within respective cylinder 22 results in a rotation of crankshaft 27. Similarly, a rotation of crankshaft 27 will result in a sliding motion of pistons 24.

The internal combustion engine 20 also includes a cylinder head 30. The cylinder head 30 defines an exhaust passageway 41 that leads to at least one exhaust port 36 for each cylinder 22. Cylinder head 30 may further define two or more exhaust ports 36 for each cylinder 22. An exhaust valve 32 is disposed within each exhaust port 36. Each exhaust valve 32 includes an exhaust valve head 40 configured to selectively block the respective exhaust port 36. A valve stem 46 extends away from exhaust valve head 40. As will be readily appreciated by those of skill in the art, each exhaust valve 32 may be actuated to move or “lift” to thereby open the respective exhaust port 36. In a cylinder 22 having a pair of exhaust ports 36 and a pair of exhaust valves 32, the pair of exhaust valves 32 may be actuated by a single valve actuation assembly or by a pair of valve actuation assemblies.

The cylinder head 30 also defines at least one intake port 38 for each cylinder 22. Each intake port 38 leads from an intake passageway 43 to the respective cylinder 22. Cylinder head 30 may further define two or more intake ports 38 for each cylinder 22. An intake valve 34 is disposed within each intake port 38. Each intake valve 34 includes an intake valve head 48 that is configured to selectively block the respective intake port 38. As with exhaust valves 32, each intake valve 34 may be actuated to move or “lift” to thereby open the respective intake port 38. In a cylinder 22 having a pair of intake ports 38 and a pair of intake valves 34, the pair of intake valves 34 may be actuated by a single valve actuation assembly or by a pair of valve actuation assemblies.

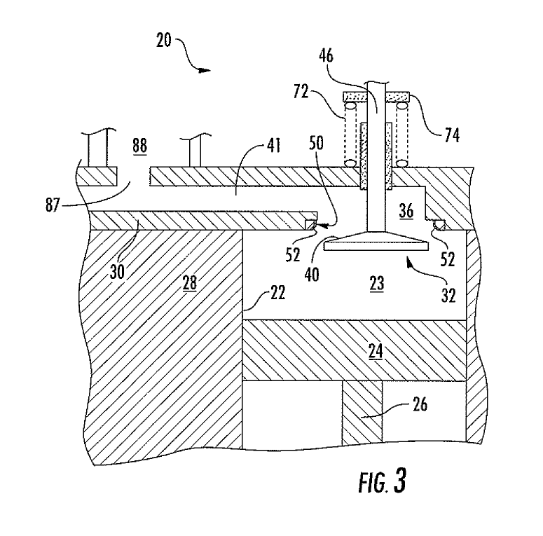

FIG. 3 illustrates an exemplary arrangement for operating an exhaust valve 32 in a cylinder 22. As will be appreciated, a similar arrangement may be used for operating a corresponding intake valve. Exhaust passageway 41 leads from an exhaust manifold opening 87 to exhaust port 36 and into combustion chamber 23. In addition, internal combustion engine 20 includes an exhaust manifold 88 that may be engaged with cylinder head 30. Exhaust gases may be directed from combustion chamber 23 through intake passageway 41 and to exhaust manifold 88.

Exhaust valve head 40 is configured to selectively engage a valve seat insert 50 in exhaust port 36. As will be described further hereinafter, valve seat insert 50 may be formed from a cobalt based alloy that has been pre-oxidized to provide enhanced surface protection. Exhaust valve head 40 may be moved between a first position where exhaust valve head 40 engages valve seat insert 50 to prevent a flow of fluid relative to exhaust port 36 and a second position (as illustrated in FIG. 3) where exhaust valve head 40 is away from the valve seat insert 50 to allow a flow of fluid relative to the exhaust port 36. A similar seating arrangement may be used in relation to intake valves 34.

Internal combustion engine 20 also includes a series of valve actuation assemblies 44. One valve actuation assembly 44 may be provided to move exhaust valve 32 between the first and second positions. Another valve actuation assembly 44 may be provided to move intake valve 34 between the first and second positions. Valve actuation assembly 44 may also include a valve spring 72. Valve spring 72 may act on valve stem 46 through a locking nut 74. Valve spring 72 may act to move exhaust valve 32 relative to cylinder head 30. In the illustrated embodiment, valve spring 72 acts to bias exhaust valve 32 into the first position, where exhaust valve head 40 engages valve seat insert 50 to prevent a flow of fluid relative to exhaust port 36.

As shown in FIG. 2, a controller 100 may be connected to each valve actuation assembly 44. Controller 100 may include an electronic control module that has a microprocessor and a memory. As is known to those skilled in the art, the memory is connected to the microprocessor and stores an instruction set and variables. Associated with the microprocessor and part of electronic control module are various other known circuits such as, for example, power supply circuitry, signal conditioning circuitry, and solenoid driver circuitry.

As will be appreciated by those of skill in the art, when exhaust valve head 40 of exhaust valve 32 engages the corresponding valve seat insert 50 to establish a sealing relation, the engaging surfaces may be subject to abrasion and wear. Eventually, as wear progresses, replacement of valve seat insert 50 and/or exhaust valve 32 may be required. Similar wear and eventual replacement is also associated with operation of intake valve heads 48 and corresponding valve seat inserts 50 that are configured to operate in the same manner. It has been found that wear of contacting surfaces may be particularly acute during an initial break-in period. Break-in periods for interfacing components are generally understood in the art, and may be defined, at least in part, as a tribological concept for the time necessary to allow interfacing surfaces to conform to one another such that they are adequately seated against one another. The duration of any given break-in period is highly dependent on the operating conditions, but generally, for the engine components highlighted herein, a suitable break-in period is less than about 250 hours of engine operation. It should be understood that a break-in period may be longer than about 250 hours, and that exemplary suitable break-in periods typically fall under 250 hours. It is contemplated that reducing wear during the initial break-in period may increase the overall life of the valve components and reduce the frequency of replacement.

In order to increase high temperature wear resistance, it is known to use nickel-based alloys to form portions of exhaust valves 32 and intake valves 34. It is also known to use cobalt-based alloys to form complementary valve seat inserts. The use of cobalt alloys may be particularly beneficial for valve seat inserts 50, which engage exhaust valve heads 40, due to the high temperatures of the exhaust gases. While such a combination of materials is beneficial, the cobalt-based valve seat inserts may nonetheless exhibit relatively higher levels of wear during an initial break-in period. Accordingly, the valve seat inserts tend to require replacement sooner than the nickel-based valve elements. The use of cobalt-based valve seat inserts exhibits some desirable mechanical and tribological properties. Likewise, nickel-based valves exhibit some beneficial traits related to structural integrity at high temperatures and reasonable cost.

As such, the present disclosure provides cobalt-based valve seat inserts 50 that have been subjected to forced pre-use oxidation before installation. Such pre-use oxidation provides a relatively thin oxide scale coating incorporating relatively small atomic percentages of cobalt oxides at the surface of the valve seat inserts prior to use. In this regard, it will be understood that the term “scale” denotes a film or layer made up predominantly of mixed metallic oxides that have been formed on the surface of an alloy by reacting the metallic constituents with oxygen at elevated temperatures. It has been discovered that wear resistance is greatly enhanced despite the relative thinness and scale character of the oxide scale surface coating. Optionally, complementary nickel-based valves that contact the valve seat inserts also may be provided with a cobalt alloy covering and be subjected to forced, pre-use oxidation before installation.

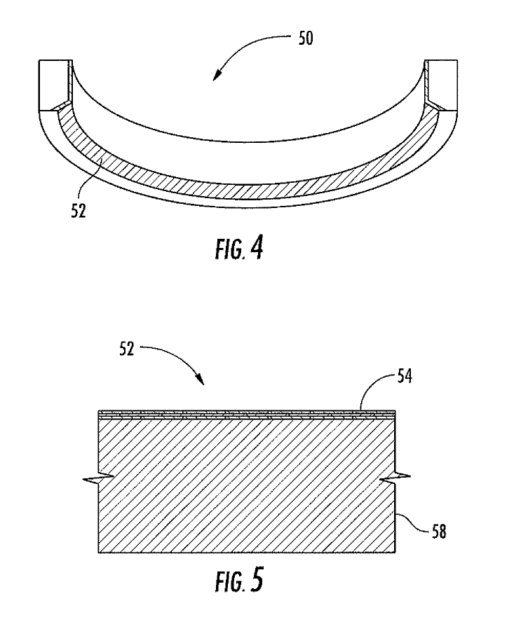

Referring jointly to FIGS. 3, 4, and 5, in one exemplary embodiment, valve seat insert 50 has a ring structure and includes angled wear face 52, which engages exhaust valve head 40 repeatedly as exhaust port 36 is opened and closed during the combustion cycle. As shown, the valve seat insert has an oxide surface scale coating 54 disposed on insert substrate 58 at least at wear face 52. By way of example only, in one embodiment a valve seat insert 50 may comprise an insert substrate 58 comprising an alloy having at least about 40 wt % Co, at least about 5 wt % Cr, and at least about 20 wt % Cr+Mo. For example, insert substrate 58 may have between about 40-65 wt % Co, such as between about 40-57 wt % Co, or between about 40-45 wt % Co. Further, the composition of Cr in the alloy for insert substrate 58 may be between about 5-35 wt %, or between about 7.5-32 wt %. Moreover, the combined amount of Cr+Mo in the allow for insert substrate 58 may be between about 20-50 wt % Cr+Mo, such as between about 25-40 wt % Cr+Mo).

In one exemplary embodiment, valve seat insert 50 may be provided that is formed with insert substrate 58 having an approximate alloy composition of about 2.2-2.6 wt % C, 0-3.0 wt % Ni, 29.0-32.0 wt % Cr, 0.4-1.0 wt % Si, 0-3.0 wt % Fe, 11.0-14.0 wt % W, 0-1.0 wt % Mn, with 0-5.0 wt % combined Mo+Fe+Ni and the balance being Co and incidental impurities. In another exemplary embodiment, valve seat insert 50 may be provided which is formed with insert substrate 58 having an alloy composition of about 26.5-29.5 wt % Mo, 7.5-8.5 wt % Cr, 2.2-2.6 wt % Si, 0-3.0 wt % combined Fe+Ni, 0-0.03 wt % P, 0-0.03 wt % S, 0-0.08 wt % C, and the balance being Co and incidental impurities. Moreover, other base alloys may be used according to this disclosure so long as they include at least about 40 wt % Co in combination with at least about 5 wt % Cr. As indicated previously, valve seat insert 50 has an outer angled wear face 52 with a relatively thin oxide scale surface coating 54 adapted to engage a complementary exhaust valve head 40 after the heat treating operation.

In one exemplary embodiment, oxide surface scale coating 54 on wear face 52 is characterized by a surface composition including less than about 10 wt % Co, such as less than about 9 wt % Co, less than about 8 wt % Co, less than about 7 wt % Co, less than about 6 wt % Co, or between about 1-5 wt % Co. Further, scale coating 54 has a surface composition including at least about 50 wt % O, such as, e.g., about 50-70 wt % O. The balance of the surface composition of scale coating 54 includes not more than about 5 wt % C, such as less than about 4 wt % C, less than about 3 wt % C, or even less than about 2 wt % C. Oxide surface scale coating 54 covering wear face 52 of valve seat insert 50 may have a thickness of up to about 1000 nm, such as, e.g., between about 1-1000 nm, between about 100-1000 nm, between about 100-500 nm, or between about 200-400 nm. In this regard, it should be understood that the oxygen content tends to diminish progressively as distance from the surface increases. Accordingly, for purposes of evaluating the thickness of oxide surface scale coating 54, coating thickness is defined as the depth at which total oxygen drops below about 5 wt %. According to the disclosure, oxide surface scale coating 54 is present after any preliminary formation or treatment practices, but before activation of an internal combustion cycle. The chemical composition may be evaluated by any suitably precise analytical technique as known to those of skill in the art. By way of example only, one suitable analytical technique for evaluation of surface chemistry is X-ray photoelectron spectroscopy (XPS), which is also known as electron spectroscopy for chemical analysis (ESCA). Such a technique is sensitive to a depth of about 10 nm. Such a system measures chemical composition as well as the electronic states of materials.

To form oxide surface scale coating 54, the valve seat insert is subjected to a heat treatment in an oxidizing atmosphere before installation of valve seat insert 50 at cylinder 22. The heat treatment may be carried out in air at an appropriate temperature, such as, e.g., between about 700-850° C., for an appropriate time, such as, e.g., between about 3-5 hours. However, the heat treatment may also be conducted in an oxygen enriched atmosphere if desired, which would likely reduce the amount of time required to form oxide surface scale coating 54. Likewise, temperatures and treatment times may be adjusted as desired. In one example, valve seat insert 50 was subjected to heat treatment in an air furnace at about 785-790° C. for a period of about 4 hours. Following the heat treatment, the surface of the valve seat insert 50—including wear face 52—was covered with a Cr-rich oxide scale coating having a thickness of about 250 nm. The resulting chemical composition at the surface of the oxide scale coating was measured to be about 4 wt % Co, 30 wt % Cr, 64 wt % O, 1 wt % C, and 1 wt % trace elements.

Exhaust valve head 40 and/or intake valve head 48 may also undergo a hardfacing treatment or comprise another overlay of a cobalt alloy held in place by a metallurgical bond. In such a configuration, the valve head having an overlay may be subjected to an oxidizing heat treatment to form an oxide scale coating having a thickness up to about 1000 nm, as previously described. The presence of such an oxide scale coating at the valve head may provide additional wear resistance.

By way of example only, exhaust valve 32 and/or intake valve 34 may be formed from a Ni-based age hardenable superalloy. In accordance with one exemplary embodiment, such Ni-based superalloys may include between about 50-75 wt % Ni, such as between about 55-65 wt % Ni, in combination with between about 15-30 wt % Cr, such as between about 20-25 wt % Cr, the balance including Fe, Ti, Al, and other minor additives and impurities. For example, one such material has a composition of about 57 wt % Ni, about 23 wt % Cr, about 14 wt % Fe, about 2 wt % Mo, about 2.3 wt % Ti, about 1.3 wt % Al, about 0.9 wt % Nb, about 0.005 wt % B, about 0.05 wt % Zr, about 0.04 wt % C, less than about 0.5 wt % Mn, less than about 0.2 wt % Si, less than about 0.02 wt % P, and less than about 0.005 wt % S.

A metallurgically bonded overlay of a Co-based alloy may be applied on at least a portion of exhaust valve head 40 and/or intake valve head 48. Such a Co-based alloy does not need to be similar to the Co-based alloy formed on valve seat insert 50. In one embodiment, the Co-based alloy applied to the valve head may have a composition including between about 2.2-2.6 wt % C, between about 0-3.0 wt % Ni, between about 29.0-32.0 wt % Cr, between about 0.4-1.0 wt % Si, between about 0-3.0 wt % Fe, between about 11.0-14.0 wt % W, between about 0-1.0 wt % between about Mn, and between about 0-5.0 wt % combined Mo+Fe+Ni, the balance being Co and incidental impurities. In another exemplary embodiment, the Co-based alloy applied to the valve head may have a composition including between about 26.5-29.5 wt % Mo, between about 7.5-8.5 wt % Cr, between about 2.2-2.6 wt % Si, between about 0-3.0 wt % combined Fe+Ni, between about 0-0.03 wt % P, between about 0-0.03 wt % S, and between about 0-0.08 wt % C, the balance being Co and incidental impurities. Moreover, other base alloys may be used according to this disclosure so long as they include at least about 40 wt % Co in combination with at least about 5 wt % Cr.

The Co-based alloy may be applied to the valve head by any suitable hardfacing techniques, such as plasma transferred arc (PTA) or laser welding. In such techniques, a powder feedstock form of the Co-based alloy is dropped into a molten weld pool that is developed progressively on the surface of the valve head being treated. The powder feedstock melts into the weld pool, then resolidifies to form the overlay. Alternatively, the overlay may be formed on the valve head by tungsten inert gas (TIG) welding, which uses a welding rod as the feedstock to build up the overlay. In this regard, various Co-based alloys as previously described may be used in wire form. In yet another alternative, the Co-based overlay may be applied by techniques such as thermal spray coating, including high velocity oxygen fuel (HVOF) or the like.

Regardless of the particular technique used to apply the Co-based overlay, the result is the formation of a metallurgically bonded layer including cobalt and chromium. Upon being subjected to an oxidizing heat treatment as described herein, the oxide scale coating previously described is developed on the overlay. The presence of this oxide scale coating at the valve head may further improve wear resistance during an initial start-up period. Portions of the valves without the Co-based overlay may also develop a Cr-rich oxide coating.

### INDUSTRIAL APPLICABILITY

In accordance with one exemplary practice, the present disclosure is applicable to valve seat inserts 50 formed from cast Co-based alloys including at least about 40 wt % Co and at least about 5 wt % Cr, which are useful in internal combustion engines in conjunction with exhaust valves 32 and/or intake valves 34. Prior to instillation in the engine, valve seat inserts 50 are subjected to a forced oxidation heat treatment in air or another oxidizing atmosphere to establish oxide surface scale coating 54. The oxide surface scale coating 54 covers a wear face 52 on an angled segment of valve seat inserts 50.

In use, the valve seat inserts 50 are installed in an internal combustion engine to engage exhaust valve heads 40 and/or intake valve heads 48. The presence of oxide surface scale coating 54 on wear face 52 prior to the initiation of an internal combustion cycle provides protection against undue wear during an initial break-in period for valve seat inserts 50. Despite the thin, scale character of the coating, the low percentage of cobalt, and high percentage of chromium relative to the base alloy, it has been discovered that the presence of the coating substantially enhances the life span of valve seat insert 50. In this regard, testing has shown that a valve seat insert 50 that is formed from the cobalt-based alloy disclosed herein and subjected to the oxidation heat treatment described herein to form a Cr-rich oxide scale coating before installation into an engine yields an average lifespan, i.e., before requiring replacement, of about 20% longer than the same insert without an oxide treatment coating. Accordingly, the frequency of required replacement is substantially diminished.

Further, exhaust valves 32 and/or intake valves 34 of an internal combustion engine may be provided with a Co-based alloy overlay and be subjected to some level of oxidizing heat treatment before installation. After forming an oxide scale coating on the cobalt alloy overlay, further wear reduction during an initial break-in period may be observed.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. Moreover, all steps in the methods described herein may be performed in any suitable order, unless otherwise indicated herein or otherwise clearly contradicted by context.

What is claimed is:

1. A valve seat insert, the valve seat insert comprising:
a cobalt alloy base including at least about 40 wt % Co in combination with at least about 5 wt % Cr; and
a wear face having an oxide scale coating disposed thereon, the oxide scale coating having a thickness of less than about 1000 nm and a surface composition including chromium, oxygen and cobalt.

2. The valve seat insert of claim 1, wherein the oxide scale coating has a thickness between about 150 nm and 400 nm.

3. The valve seat insert of claim 1, wherein the oxide scale coating has a thickness between about 200 nm and 300 nm.

4. The valve seat insert of claim 1, wherein the cobalt alloy base further includes at least about 8 wt % W and less than about 3 wt % C.

5. The valve seat insert of claim 4, wherein the oxide scale coating has a surface composition including at least about 50 wt % 0, less than about 10 wt % Co, and less than about 5 wt % C.

6. The valve seat insert of claim 1, wherein the cobalt alloy base includes the following approximate composition, by wt %:

| | |
|---|---|
| C | 2.2-2.6 |
| Cr | 29.0-32.0 |
| Si | 0.4-1.0 |
| W | 11.0-14.0 |
| Mn | 0-1.0 |
| Fe | less than about 3.0 |
| Ni | less than about 3.0 |
| Mo + Fe +Ni | 0-5.0 |

wherein the balance includes Co and incidental impurities.

7. The valve seat insert of claim 1, wherein the cobalt alloy base includes the following approximate composition, by wt %:

| | |
|---|---|
| Mo | 26.5-29.5 |
| Cr | 7.5-8.5 |
| Si | 2.2-2.6 |
| S | 0-0.03 |
| P | 0-0.03 |
| C | 0-0.08 |
| Fe + Ni | 0-3.0 |

wherein the balance includes Co and incidental impurities.

8. The valve seat insert of claim 7, wherein the oxide scale coating has a thickness between about 200 nm to 300 nm.

9. A valve assembly adapted to selectively open and close a passage to a cylinder in an internal combustion engine during a plurality of combustion cycles, the valve assembly comprising:
a valve seat insert having a cobalt alloy base including at least about 40 wt % Co and at least about 5 wt % Cr; and
a moveable valve including a valve head, the valve head being at least partially covered with a cobalt alloy overlay;
wherein the valve seat insert further includes a wear face having a first oxide scale coating disposed thereon, the first oxide scale coating having a thickness of less than about 1000 nm and a surface composition including less than about 10 wt % Co.

10. The valve assembly of claim 9, wherein a second oxide scale coating is disposed on an outer surface of the cobalt alloy overlay.

11. The valve assembly of claim 9, wherein the first oxide scale coating has a thickness between about 150 nm and 400 nm.

12. The valve assembly of claim 9, wherein the first oxide scale coating has a thickness between about 200 nm and 300 nm.

13. The valve assembly of claim 9, wherein the first oxide scale coating has a surface composition including at least about 50 wt % O, less than about 8 wt % Co, and less than about 5 wt % C.

14. The valve assembly of claim 9, wherein the cobalt alloy base further includes at least about 8 wt % W and less than about 3 wt % C.

15. The valve assembly of claim 9, wherein the cobalt alloy base includes the following approximate composition, by wt %:

| | |
|---|---|
| C | 2.2-2.6 |
| Cr | 29.0-32.0 |
| Si | 0.4-1.0 |
| W | 11.0-14.0 |
| Mn | 0-1.0 |
| Fe | less than about 3.0 |
| Ni | less than about 3.0 |
| Mo + Fe + Ni | 0-5.0 |

wherein the balance includes Co and incidental impurities.

16. The valve assembly as recited in claim 9, wherein the cobalt alloy base includes the following approximate composition, by wt %:

| | |
|---|---|
| Mo | 26.5-29.5 |
| Cr | 7.5-8.5 |
| Si | 2.2-2.6 |
| S | 0-0.03 |
| P | 0-0.03 |
| C | 0-0.08 |
| Fe +Ni | 0-3.0 |

wherein the balance includes Co and incidental impurities.

17. The valve assembly as recited in claim 16, wherein the first oxide scale coating has a thickness between about 200 nm and 300 nm.

18. A method for extending the useful life of a valve seat insert for use in conjunction with a valve adapted to selectively open and close a passage to a cylinder in an internal combustion engine during a plurality of combustion cycles, the method comprising:
forming the valve seat insert from a cobalt alloy including at least about 40% Co and least about 5% Cr;
subjecting the valve seat insert to an oxidizing heat treatment to form an oxide scale coating disposed on a valve seat insert wear face that is adapted to engage the valve, wherein the oxide scale coating has a thickness up to about 1000 nm.

19. The method as recited in claim 19, wherein the cobalt alloy base includes the following approximate composition, by wt %:

| | |
|---|---|
| C | 2.2-2.6 |
| Cr | 29.0-32.0 |
| Si | 0.4-1.0 |
| W | 11.0-14.0 |
| Mn | 0-1.0 |
| Fe | less than about 3.0 |
| Ni | less than about 3.0 |
| Mo + Fe + Ni | 0-5.0 |

wherein the balance includes Co and incidental impurities; and
wherein the oxide scale coating has a thickness in the range of about 100 nm to 400 nm.

20. The method as recited in claim 19, wherein the cobalt alloy base includes the following approximate composition, by wt %:

| | |
|---|---|
| Mo | 26.5-29.5 |
| Cr | 7.5-8.5 |
| Si | 2.2-2.6 |
| S | 0-0.03 |
| P | 0-0.03 |
| C | 0-0.08 |
| Fe + Ni | 0-3.0 |

wherein the balance includes Co and incidental impurities; and
wherein the oxide scale coating has a thickness in the range of about 100 nm to 400 nm.
